(19) United States
(12) Patent Application Publication
(10) Pub. No.: US 2025/0343484 A1
(43) Pub. Date: Nov. 6, 2025

(54) DC-DC CONVERTER

(71) Applicant: SAMSUNG ELECTRONICS CO., LTD., SUWON-SI (KR)

(72) Inventors: Woosuk CHOI, Suwon-si (KR); Sangbeom LEE, Suwon-si (KR); Hyunjun LEE, Suwon-si (KR)

(21) Appl. No.: 19/013,161

(22) Filed: Jan. 8, 2025

(30) Foreign Application Priority Data
May 3, 2024 (KR) 10-2024-0059103

(51) Int. Cl. H02M 3/158; H02M 1/00

(52) U.S. Cl. CPC H02M 3/158; H02M 1/0009

(57) ABSTRACT

A direct current (DC)-DC converter including: a voltage conversion circuit that includes an inductor and an output capacitor, and converts an input voltage and to produce an output voltage; a current detection circuit that detects an inductor current and generates a sensing current during an on-time, energizing the inductor current flowing through the inductor; a pulse skip reference voltage generation circuit that generates a sensing voltage and a pulse skip reference voltage using the sensing current; and a control circuit that determines whether to skip a pulse of the voltage conversion circuit and controls the on-time, using the sensing voltage, the pulse skip reference voltage, and a feedback voltage proportional to the output voltage, wherein the pulse skip reference voltage generation circuit generates the pulse skip reference voltage by sampling the sensing voltage during a reference on-time.

### CROSS-REFERENCE TO RELATED APPLICATION

This application claims priority under 35 U.S.C. § 119(a) to Korean Patent Application No. 10-2024-0059103 filed on May 3, 2024 in the Korean Intellectual Property Office, the disclosure of which is incorporated by reference herein in its entirety.

### TECHNICAL FIELD

The present inventive concept relates to a direct current (DC)-DC converter.

### DISCUSSION OF RELATED ART

Electronic devices are powered by voltage supplied from either a battery or an external source. Typically, a direct current (DC) voltage provided by a battery or similar source may be converted into a DC voltage suitable for other devices within the device using a DC-DC converter. Under heavy load conditions, the DC-DC converter may operate in a normal mode. In the normal mode, the DC-DC converter may control power output to the load by regulating the switching cycle through pulse width modulation (PWM) using a clock signal. When there is little to no load, the DC-DC converter switches from the normal mode to a pulse skip mode (PSM), where it conserves power by skipping unnecessary switching cycles.

### SUMMARY

Example embodiments of the present inventive concept provide a direct current (DC)-DC converter designed to prevent voltage overshoot or undershoot during mode transitions between a pulse skip mode and a normal mode.

According to example embodiments of the present inventive concept, there is provided a DC-DC converter including: a voltage conversion circuit that includes an inductor and an output capacitor, and converts an input voltage and to produce an output voltage; a current detection circuit that detects an inductor current and generates a sensing current during an on-time, energizing the inductor current flowing through the inductor; a pulse skip reference voltage generation circuit that generates a sensing voltage and a pulse skip reference voltage using the sensing current; and a control circuit that determines whether to skip a pulse of the voltage conversion circuit and controls the on-time, using the sensing voltage, the pulse skip reference voltage, and a feedback voltage proportional to the output voltage, wherein the pulse skip reference voltage generation circuit generates the pulse skip reference voltage by sampling the sensing voltage during a reference on-time.

According to example embodiments of the present inventive concept, there is provided a DC-DC converter including: a voltage conversion circuit that includes an inductor, an output capacitor, a first switching element, and a second switching element, and converts an input voltage to produce an output voltage; a current detection circuit that generates a sensing current by detecting an inductor current during an on-time, energizing the inductor current flowing through the inductor; a pulse skip reference voltage generation circuit that generates a sensing voltage and a pulse skip reference voltage using the sensing current; and a control circuit including an error amplifier that outputs an error amplification voltage by comparing a feedback voltage proportional to the output voltage with a reference voltage, determines whether to skip a pulse of the voltage conversion circuit using the pulse skip reference voltage and the error amplification voltage, and controls the on-time using the sensing voltage and the error amplification voltage, wherein the pulse skip reference voltage generation circuit includes a first capacitor, a second capacitor, a first switch and a second switch, samples the sensing voltage in the first capacitor during a reference on-time, and generates the pulse skip reference voltage by holding the sampled voltage in the first capacitor and the second capacitor during an off-time when the inductor current flowing in the inductor is de-energized.

According to example embodiments of the present inventive concept, there is provided a DC-DC converter including: a voltage conversion circuit that includes an inductor, an output capacitor, a first switching element and a second switching element, and converts an input voltage to produce an output voltage; a current detection circuit that generates a sensing current by detecting an inductor current during an on-time, energizing the inductor current flowing through the inductor; a pulse skip reference voltage generation circuit that includes a first capacitor and a second capacitor connected in parallel, and a first switch and a second switch connected in series, and generates a sensing voltage and a pulse skip reference voltage using the sensing current; and a control circuit including an error amplifier that outputs an error amplification voltage by comparing a feedback voltage proportional to the output voltage with a reference voltage, determines whether to skip a pulse of the voltage conversion circuit using the pulse skip reference voltage and the error amplification voltage, and controls the on-time using the sensing voltage and the error amplification voltage, wherein in the pulse skip reference voltage generation circuit, a first end of the first capacitor and a first end of the second capacitor are connected to ground, a second end of the first capacitor is connected to a node between the first switch and the second switch, and a second end of the second capacitor is connected to the second switch, and the sensing voltage is sampled in the first capacitor by maintaining the first switch in an on-state during a reference on-time, the sampled voltage is held in the first capacitor and the second capacitor by maintaining the second switch in an on-state during an off-time when the inductor current is de-energized, and the pulse skip reference voltage is generated, and the voltage conversion circuit skips pulses when the pulse skip reference voltage is greater than the error amplification voltage.

### BRIEF DESCRIPTION OF DRAWINGS

The above and other features of the present inventive concept will be more clearly understood from the following detailed description, taken in conjunction with the accompanying drawings, in which:

FIG. 1 is a block diagram schematically illustrating a direct current (DC)-DC converter according to an example embodiment;

FIG. 2 is a circuit diagram schematically illustrating a DC-DC converter according to an example embodiment;

FIG. 3 is a diagram illustrating operations of a DC-DC converter in a pulse skip mode according to an example embodiment;

FIG. 4 is a circuit diagram schematically illustrating a pulse skip reference voltage generation circuit according to an example embodiment;

FIGS. 5 and 6 are circuit diagrams illustrating operations of the pulse skip reference voltage generation circuit according to an example embodiment illustrated in FIG. 4;

FIG. 7 is a graph illustrating a pulse skip reference voltage according to an example embodiment;

FIGS. 8A, 8B, 8C, 8D, 9A, 9B, 9C, and 9D are diagrams illustrating operations of a DC-DC converter according to example embodiments;

FIG. 10 is a block diagram of an electronic device including a DC-DC converter according to an example embodiment; and

FIG. 11 is a block diagram of an electronic device including a DC-DC converter according to an example embodiment.

### DETAILED DESCRIPTION OF THE EMBODIMENTS

Hereinafter, example embodiments of the present inventive concept will be described with reference to the accompanying drawings.

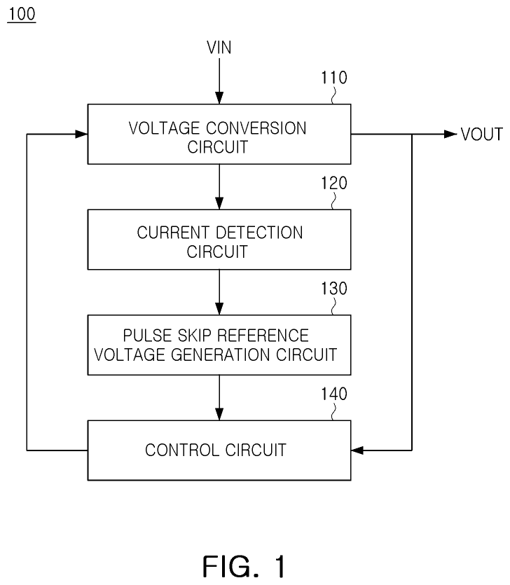

FIG. 1 is a block diagram schematically illustrating a DC-DC converter according to an example embodiment.

Referring to FIG. 1, a DC-DC converter 100 according to an example embodiment may include a voltage conversion circuit 110, a current detection circuit 120, a pulse skip reference voltage generation circuit 130, a control circuit 140, and the like. The DC-DC converter 100 may be implemented as a standalone unit or integrated within a power management integrated circuit (PMIC). Power management integrated circuits may also be integrated on semiconductor substrates.

The DC-DC converter 100 may convert an input voltage VIN and provide an an output voltage VOUT. The input voltage VIN may be a direct current (DC) voltage from a DC power source such as a battery or voltage regulator. The output voltage VOUT may be output to a load connected to the DC-DC converter 100. The DC-DC converter 100 may function as a buck converter that lowers the output voltage VOUT relative to the input voltage VIN, or as a boost converter that increases the output voltage VOUT relative to the input voltage VIN. However, the present inventive concept may not be limited thereto.

In some example embodiments, the voltage conversion circuit 110 may include an inductor and an output capacitor, and may further include a first switching element and a second switching element. The type of DC-DC converter 100 may be determined based on the configuration of elements included in the voltage conversion circuit 110.

The first switching element and the second switching element may alternate states according to a switching cycle, which can be determined by a clock signal. A switching cycle may include an on-time and an off-time. In an example, the off-time may be longer than the on-time, but the present inventive concept is not limited thereto.

During on-time and off-time, the states of the first switching element and the second switching element may be complementary. For example, during the on-time, the first switching element may be in an on (closed) state and the second switching element may be in an off (open) state. During the off-time, the first switching element may be in an off-state and the second switching element may be in an on-state.

The on-time may correspond to the period during which the inductor current, flowing in the inductor in the voltage conversion circuit 110, is energized. In detail, energy may be accumulated in the inductor during the on-time. The off-time may correspond to the period when the inductor current is de-energized, during which the stored energy in the inductor is released.

The operation mode of the DC-DC converter 100 may be divided into a normal mode and a pulse skip mode (PSM). The DC-DC converter 100 with a heavy load may be operated in normal mode. The DC-DC converter 100 may determine the switching cycle by controlling pulse width modulation (PWM) using a clock signal. Accordingly, the DC-DC converter 100 may output the current required by the load.

If the power output by the DC-DC converter 100 under no-load or light load conditions is greater than the power consumed by the load, the DC-DC converter 100 may operate in the pulse skip mode. In this mode, skipping the switching cycle reduces the number of operations of the first switching element and the second switching element, thereby preventing recharging of the inductor. Therefore, switching efficiency may be improved and unnecessary power loss may be prevented. Additionally, the on-time of the DC-DC converter 100 in the pulse skip mode may be controlled using a reference on-time. In an example, the reference on-time may correspond to a minimum on-time.

The current detection circuit 120 may detect the inductor current and generate a sensing current. In some example embodiments, the current detection circuit 120 may generate a sensing current by detecting the inductor current only during the on-time. During the off-time, the inductor current is not detected, and thus, the sensing current may correspond to 0. The sensing current may be calculated as a constant multiple of the inductor current. The constant multiple may be less than 1; however, it is not restricted to this value and could vary.

In some example embodiments, the pulse skip reference voltage generation circuit 130 may generate a sensing voltage and a pulse skip reference voltage using a sensing current. The sensing current and sensing voltage may have peak values at the end of the reference on-time. The pulse skip reference voltage may correspond to a direct current voltage.

The control circuit 140 may include an error amplifier that compares a feedback voltage and the reference voltage and outputs an error amplification voltage. The control circuit 140 may determine whether to skip the pulse of the voltage conversion circuit, and control the on-time. In detail, the control circuit 140 may determine whether to skip pulses in the voltage conversion circuit using the pulse skip reference voltage and the error amplification voltage. Additionally, the control circuit 140 may control the on-time using the sensing voltage and the error amplification voltage. For example, the control circuit 140 may control the duration of the on-time.

When switching modes between the pulse skip mode and the normal mode, it is important that the inductor current of the DC-DC converter 100 changes stably in response to changes in the load. For example, if an input transient (line transient) or a load transient occurs, and the DC-DC converter 100 needs to switch from the pulse skip mode to the normal mode, the inductor current may increase only when the error amplification voltage rises to or exceeds the peak value of the sensing voltage. In detail, the shorter the error amplification voltage reaches or surpasses the peak value of the sensing voltage, the more stable the increase in the inductor current.

A general pulse skip reference voltage generation circuit may generate a pulse skip reference voltage by sampling the sensing voltage during the off-time. Since the sensing voltage may be maintained at a low level during the off-time, the pulse skip reference voltage may have a value close to the low level of the sensing voltage. Accordingly, it may take a predetermined amount of time for the error amplification voltage to rise to the peak value or higher than the sensing voltage, leading to a delay in the increase of the inductor current for a certain period.

The pulse skip reference voltage generation circuit 130 according to an example embodiment may generate a pulse skip reference voltage by sampling the sensing voltage during the reference on-time. Since the sensing voltage may have a peak value at the end of the reference on-time, the pulse skip reference voltage may have a value close to the peak value of the sensing voltage. Accordingly, the error amplification voltage is immediately increased to the peak value or higher than the sensing voltage, enabling the inductor current to increase in a stable manner.

Therefore, the DC-DC converter 100 according to an example embodiment generates a pulse skip reference voltage by sampling the sensing voltage during the reference on-time, ensuring that the error amplification voltage does not limit the change in inductor current. In detail, during the transition between the pulse skip mode and the normal mode, the inductor current adjusts stably in response to changes in load. This prevents overshoot or undershoot in the output of the DC-DC converter 100, thereby maintaining stable output.

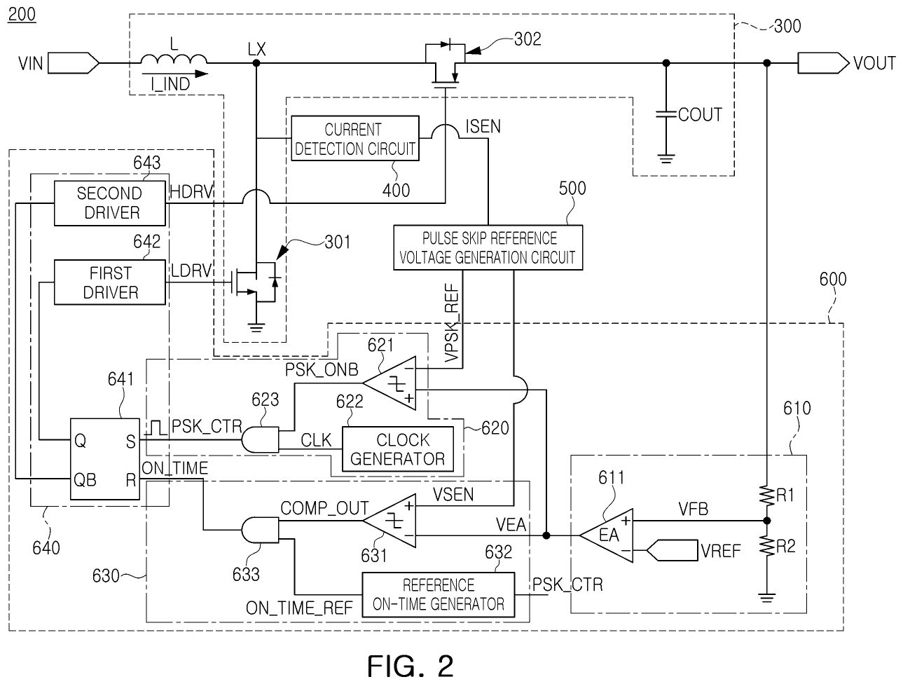

FIG. 2 is a circuit diagram schematically illustrating a DC-DC converter according to an example embodiment.

First, referring to FIG. 2, a DC-DC converter 200 according to an example embodiment may include a voltage conversion circuit 300, a current detection circuit 400, a pulse skip reference voltage generation circuit 500, a control circuit 600, and the like. The DC-DC converter 200 may convert the input voltage VIN and output an output voltage VOUT to the connected load. The DC-DC converter 200 of an example embodiment illustrated in FIG. 2 may correspond to a boost converter that increases the output voltage VOUT relative to the input voltage VIN. However, the present inventive concept may not be limited thereto.

The voltage conversion circuit 300 may convert the input voltage VIN to the output voltage VOUT. The voltage conversion circuit 300 may include an inductor L, an output capacitor COUT, a first switching element 301, and a second switching element 302. The inductor L and the second switching element 302 may be connected in series between an input terminal that receives the input voltage VIN and an output terminal that outputs the output voltage VOUT. The first switching element 301 may be connected between a node LX between the inductor L and the second switching element 302 and the ground node. The output capacitor COUT may be connected between the output terminal and a ground node.

The first switching element 301 may include a first power transistor and a first diode. The first power transistor may correspond to a low side power transistor and may be implemented as N-channel Metal-Oxide-Semiconductor (NMOS). The first diode may correspond to a low side diode and may be connected between the source and drain of the first power transistor.

The second switching element 302 may include a second power transistor and a second diode. The second power transistor may correspond to a high side power transistor and may be implemented as P-channel Metal-Oxide-Semiconductor (PMOS). The second diode may correspond to a high side diode and may be connected between the source and drain of the second power transistor.

The current detection circuit 400 may detect an inductor current I_IND flowing through the inductor L to generate and output a sensing current ISEN. For example, the current detection circuit 400 may be connected between the node LX and the first switching element 301 and detect the inductor current I_IND only while the first switching element 301 is in the off-state. The sensing current ISEN may be calculated as a constant multiple of the inductor current I_IND. Certain multiples may be less than 1. For example, the constant multiple may be 0.001, but may not be limited thereto.

The control circuit 600 may include an error amplification circuit 610, a pulse skip control circuit 620, an on-time control circuit 630, and a switching circuit 640.

The error amplification circuit 610 may include a first resistor R1, a second resistor R2, and an error amplifier (EA) 611. The first resistor R1 and the second resistor R2 are connected in series between the output terminal and the ground node. A feedback voltage VFB may be generated using the voltage divider formed the first resistor R1 and the second resistor R2. The error amplifier 611 may output an error amplification voltage VEA by comparing the feedback voltage VFB, applied to the inverting terminal, with the reference voltage VREF, applied to the non-inverting terminal.

The pulse skip control circuit 620 may output a pulse skip control signal PSK_CTR, which determines whether to skip a pulse in the voltage conversion circuit 300 by using a pulse skip reference voltage VPSK_REF and the error amplification voltage VEA. The pulse skip control circuit 620 may include a first comparator 621, a clock generator 622, and a first AND operator 623.

The first comparator 621 may output an inverted pulse skip signal PSK_ONB by comparing the level of the pulse skip reference voltage VPSK_REF input to the inverting terminal with the level of the error amplification voltage VEA input to the non-inverting terminal. The pulse skip period, during which the pulse is skipped, may be determined based on the inverted pulse skip signal PSK_ONB.

When the level of the error amplification voltage VEA is equal to or higher than the level of the pulse skip reference voltage VPSK_REF, the inverted pulse skip signal PSK_ONB with a high level may be generated. When the level of the error amplification voltage VEA is lower than the level of the pulse skip reference voltage VPSK_REF, the inverted pulse skip signal PSK ONB with a low level may be generated.

The clock generator 622 may generate a clock signal CLK with a constant cycle. The first AND operator 623 may output the pulse skip control signal PSK_CTR by multiplying the inverted pulse skip signal PSK_ONB and the clock signal CLK. The decision to skip the pulse may be determined based on the pulse skip control signal PSK_CTR.

The on-time control circuit 630 may control the on-time using a sensing voltage VSEN and the error amplification voltage VEA. For example, the on-time control circuit 630 may control the duration of the on-time. The on-time control circuit 630 may include a second comparator 631, a reference on-time generator 632, and a second AND operator 633.

The second comparator 631 may compare the level of the error amplification voltage VEA input to the inverting terminal with the level of the sensing voltage VSEN input to the non-inverting terminal, and may output a comparison output signal COMP_OUT. The operation of the second comparator 631 may be similar to the first comparator 621.

The reference on-time generator 632 may receive the pulse skip control signal PSK_CTR from the pulse skip control circuit 620 and output a reference on-time signal ON TIME REF. The reference on-time may correspond to the reference time for energizing the inductor current I_IND flowing through the inductor L. The second AND operator 633 may output an on-time control signal ON_TIME by multiplying the comparison output signal COMP_OUT and the reference on-time signal ON_TIME_REF. The end point of the on-time is determined by the on-time control signal ON_TIME, and the duration of the on-time may be controlled.

The switching circuit 640 may include an SR latch 641, a first driver 642, and a second driver 643. The SR latch 641 may perform an SR latch operation on the pulse skip control signal PSK_CTR input to the set input S and the on-time control signal ON_TIME input to the reset input R. The SR latch 641 may provide the operation result to the first driver 642 through the output terminal Q, and provide the inversion operation result to the second driver 643 through the inversion output terminal QB. The operation result and the inversion operation result may be complementary signals.

The first driver 642 may generate a first gate control signal LDRV by amplifying the operation result of the SR latch 641. While the first gate control signal LDRV is at a high level, the first switching element 301 may remain in the off-state. The on-time of the DC-DC converter 200 may correspond to the time that the first switching element 301 remains in the off-state.

The second driver 643 may generate a second gate control signal HDRV by amplifying the result of the inversion operation of the SR latch 641. While the second gate control signal HDRV is at a high level, the second switching element 302 may remain in the off-state. The off-time of the DC-DC converter 200 may correspond to the time that the second switching element 302 remains in the off-state.

The pulse skip reference voltage generation circuit 500 may generate the sensing voltage VSEN and the pulse skip reference voltage VPSK_REF using the sensing current ISEN. In detail, the pulse skip reference voltage generation circuit 500 in some example embodiments may generate the pulse skip reference voltage VPSK_REF by sampling the sensing voltage VSEN during the reference on-time.

Since the sensing voltage VSEN reaches its peak value at the end of the reference on-time, the pulse skip reference voltage VPSK_REF may have a value close to the peak value of the sensing voltage VSEN. As a result, the inductor current changes stably in response to load changes within the operating mode of the DC-DC converter 200. This helps maintain a stable output by preventing overshoot or undershoot in the output of the DC-DC converter 200.

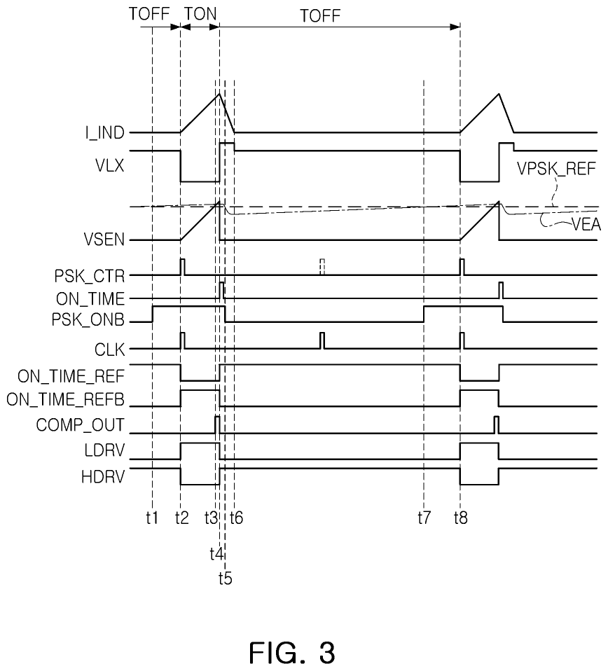

Below, the operation of the DC-DC converter 200 is described in detail with reference to FIG. 3.

FIG. 3 is a diagram illustrating the operation of the DC-DC converter in the pulse skip mode according to an example embodiment.

The DC-DC converter according to an example embodiment may include a voltage conversion circuit, a current detection circuit, a pulse skip reference voltage generation circuit, and a control circuit. Referring to FIG. 3, the inductor current I_IND periodically increases and decreases, and may have a point where it decreases to a low level. Therefore, the DC-DC converter may operate in discontinuous conduction mode (DCM). Detailed embodiments of the DC-DC converter may be similar to those previously described in FIGS. 1 and 2.

The pulse skip reference voltage generation circuit in some example embodiments may generate the pulse skip reference voltage VPSK_REF by sampling the sensing voltage VSEN during the on-time TON. Since the sensing voltage VSEN may have a peak value at the end of the on-time TON, the pulse skip reference voltage VPSK_REF may have a value close to the peak value of the sensing voltage VSEN.

Before a second time point t2, the first gate control signal LDRV is at a low level and the second gate signal HDRV is at a high level, thereby corresponding to the off-time TOFF of the DC-DC converter. During the off-time TOFF, the level of the error amplification voltage VEA may increase, and the level of a node voltage VLX at the node LX between the inductor L and the second switching element 302 may be equal to the level of the input voltage VIN.

After a first time point t1, the level of the error amplification voltage VEA may be equal to or higher than the level of the pulse skip reference voltage VPSK_REF. Accordingly, the inverted pulse skip signal PSK_ONB may change from a low level to a high level at the first time point t1.

At the second time point t2, the clock signal CLK changes from a low level to a high level, and may then be maintained for a predetermined period. At the second time point t2, the pulse skip control signal PSK_CTR may change from a low level to a high level, and the reference on-time signal ON_TIME_REF may change from a high level to a low level. The reference on-time signal ON_TIME_REF may remain at a low level for the reference on-time. The level of the inversion reference on-time signal ON_TIME_REFB may be complementary to the level of the reference on-time signal ON_TIME_REF.

In addition, at the second time point t2, the first gate control signal LDRV changes from a low level to a high level, and changes from the off-time TOFF to the on-time TON of the DC-DC converter. After the second time point t2, the level of the inductor current I_IND may increase. Accordingly, the level of the sensing voltage VSEN may increase, and the level of the node voltage VLX at the node LX between the inductor L and the second switching element 302 may be lowered.

After a third time point t3, the level of the sensing voltage VSEN may be equal to or higher than the level of the error amplification voltage VEA. Accordingly, the comparison output signal COMP_OUT may change from a low level to a high level at the third time point t3.

As the reference on-time signal ON_TIME_REF changes from the low level to the high level at a fourth time point t4, the on-time control signal ON_TIME may change from the low level to the high level. The on-time control signal ON_TIME may be maintained at a high level for a predetermined period of time.

Since the on-time control signal ON_TIME changes to a high level at the fourth time point t4, the first gate control signal LDRV may change from a high level to a low level, thereby changing from the on-time TON to the off-time TOFF of the DC-DC converter. The on-time TON of the DC-DC converter may correspond to the time of the second time point t2 to the fourth time point t4. In detail, the on-time TON of the DC-DC converter in the pulse skip mode may be the same as the reference on-time. The reference on-time may be a minimum on-time.

After the fourth time point t4, the level of the inductor current I_IND may be lowered, and after a sixth time point t6, the inductor current I_IND may be maintained at a low level. Accordingly, the level of the node voltage VLX at the node LX between the inductor L and the second switching element 302 may be increased at the fourth time point t4 and may be lowered to the level of the input voltage VIN at the sixth time point t6.

The level of the sensing voltage VSEN may have a peak value at the fourth time point t4 and may be maintained at a low level after the fourth time point t4. After the fourth time point t4, the level of the sensing voltage VSEN may be lower than the level of the error amplification voltage VEA, and the comparison output signal COMP_OUT may change from a high level to a low level.

During a fifth time point t5 to a seventh time point t7, the level of the sensing voltage VSEN may be equal to or lower than the level of the pulse skip reference voltage VPSK_REF. The inverted pulse skip signal PSK_ONB changes from the high level to the low level at the fifth time point t5 and may maintain the low level until the seventh time point t7. The section in which the inverted pulse skip signal PSK_ONB is maintained at a low level may correspond to the pulse skip section. In other words, the period during which the inverted pulse skip signal PSK_ONB is held at a low level may correspond to the pulse skip section, and in the example embodiment illustrated in FIG. 3, the fifth time point t5 to the seventh time point t7 may be the pulse skip section.

Since the inverted pulse skip signal PSK_ONB is maintained at a low level in the pulse skip section, the pulse skip control signal PSK_CTR may be maintained at a low level even if the clock signal CLK changes from a low level to a high level. Accordingly, the first gate control signal LDRV is maintained at a low level, so that the switching cycle of the DC-DC converter may be skipped and the off-time TOFF may be maintained.

The operation of the DC-DC converter after the seventh time point t7 may be similar to the operation after the first time point t1 described above. At an eighth time point t8, the first gate control signal LDRV changes from a low level to a high level, thereby changing from an off-time TOFF to an on-time TON of the DC-DC converter. The off-time TOFF of the DC-DC converter may correspond to the time from the fourth time point t4 to the eighth time point t8.

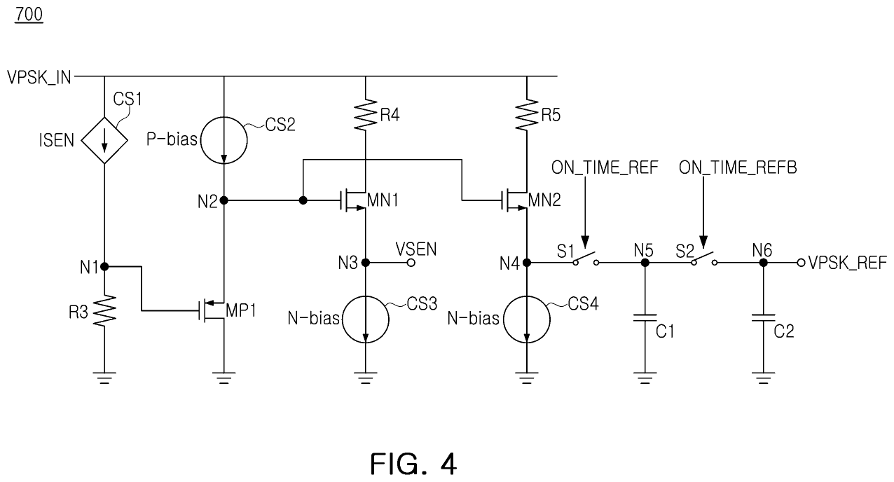

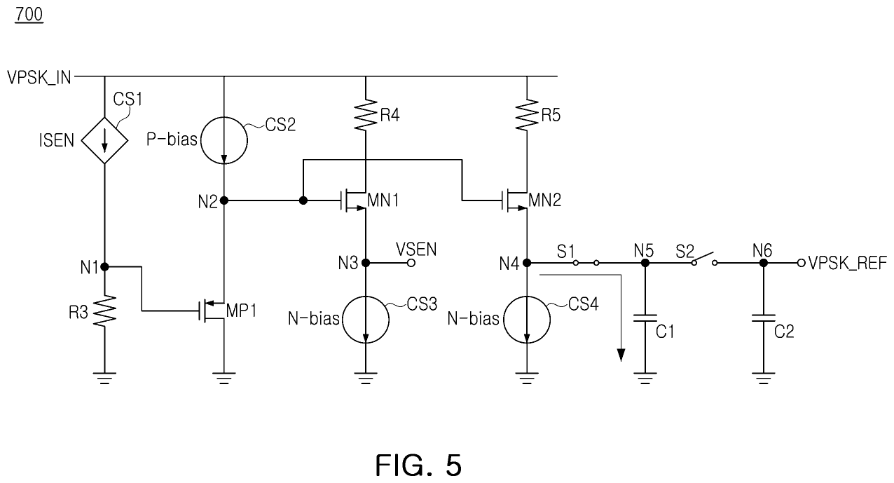

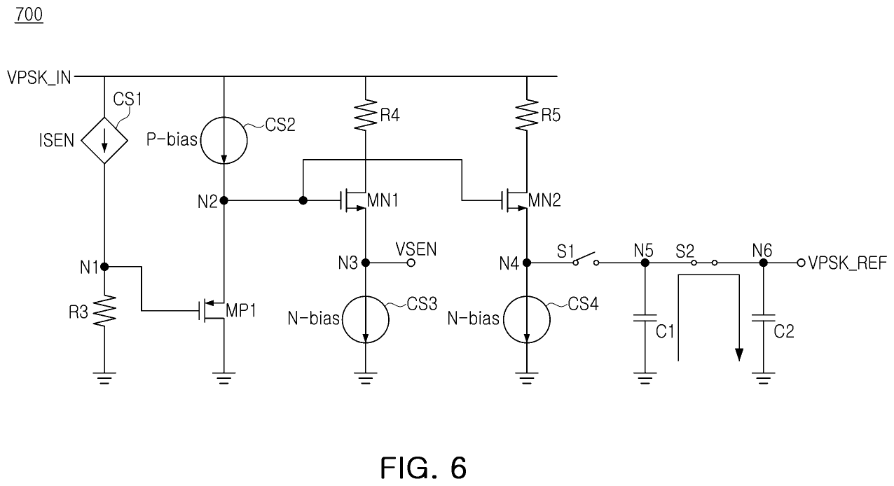

FIG. 4 is a circuit diagram schematically illustrating a pulse skip reference voltage generation circuit according to an example embodiment. FIGS. 5 and 6 are circuit diagrams illustrating the operation of the pulse skip reference voltage generation circuit according to an example embodiment illustrated in FIG. 4.

The DC-DC converter may include a voltage conversion circuit including an inductor, a current detection circuit, a pulse skip reference voltage generation circuit, and a control circuit. The current detection circuit may generate a sensing current by detecting the inductor current during the on-time period of energizing the inductor current flowing through the inductor. Detailed embodiments of the DC-DC converter may be similar to those previously described in FIGS. 1 to 3.

Referring to FIGS. 4 to 6, a pulse skip reference voltage generation circuit 700 according to an example embodiment may generate the sensing voltage VSEN and the pulse skip reference voltage VPSK_REF using the sensing current ISEN. A pulse skip input voltage VPSK_IN may be input to the input node of the pulse skip reference voltage generation circuit 700.

A first current source CS1 connected between the input node and a third resistor R3 may generate a sensing current ISEN. Similar to what was previously described in FIG. 2, the sensing current ISEN may be calculated as a constant multiple of the inductor current in the voltage conversion circuit, with the inductor current varying over time. Accordingly, the first current source CS1 may be a dependent current source.

The second current source CS2 connected between the input node and a first PMOS transistor MP1 may generate a P-bias current (P-bias). For example, the second current source CS2 corresponds to an independent current source, and the P-bias current (P-bias) may be constant. The gate terminal of the first PMOS transistor MP1 may be connected to a first node N1, the source terminal of the first PMOS transistor MP1 may be connected to a second node N2, and the drain terminal of the first PMOS transistor MP1 may be connected to a ground terminal.

A fourth resistor R4, a first NMOS transistor NM1, and a third current source CS3 may be connected in series between the input terminal and the ground terminal. The gate terminal of the first NMOS transistor NM1 may be connected to the second node N2, the drain terminal of the first NMOS transistor NM1 may be connected to the fourth resistor R4, and the source terminal of the first NMOS transistor NM1 may be connected to the third current source CS3. The third current source CS3 may generate an N-bias current (N-bias). For example, the third current source CS3 corresponds to an independent current source, and thus, the N-bias current (N-bias) may be constant.

The voltage of the first node N1 may be the voltage applied to the third resistor R3, and the voltage of the first node N1 may change according to the sensing current ISEN. Due to the gate-source voltage of the activated first PMOS transistor PM1 and the gate-source voltage of the activated first NMOS transistor NM1, the voltage of the third node N3 may be the same as the voltage of the first node N1. For example, the sensing voltage VSEN may be equal to the voltage of the first node N1. A detailed embodiment of the sensing voltage VSEN may be similar to that described previously in FIG. 3, where the sensing voltage VSEN reaches its peak value at the transition from on-time to off-time.

A fifth resistor R5, a second NMOS transistor NM2, and a fourth current source CS4 may be connected in series between the input terminal and the ground terminal. The gate terminal of the second NMOS transistor NM2 may be connected to the second node N2, the drain terminal of the second NMOS transistor NM2 may be connected to the fifth resistor R5, and the source terminal of the second NMOS transistor NM2 may be connected to the fourth current source CS4. The fourth current source CS4 may generate an N-bias current (N-bias). For example, the fourth current source CS4 corresponds to an independent current source, and thus the N-bias current (N-bias) may be constant.

In some example embodiments, the second NMOS transistor NM2 may be the same as the first NMOS transistor NM1. The fifth resistor R5 is the same as the fourth resistor R4, and the fourth current source CS4 may generate the same N-bias current (N-bias) as the third current source CS3. Since the gate terminal of the second NMOS transistor NM2 is connected to the second node N2 in the same manner as the first NMOS transistor NM1, the voltage of the fourth node N4 may be the same as the voltage of the third node N3. In detail, the voltage of the fourth node N4 may be equal to the sensing voltage VSEN.

The pulse skip reference voltage generation circuit 700 according to an example embodiment may include a first capacitor C1, a second capacitor C2, a first switch S1, and a second switch S2. The first capacitor C1 and the second capacitor C2 may be connected in parallel, and the first switch S1 and the second switch S2 may be connected in series. A first end of the first capacitor C1 may be connected to the ground terminal, and a second end of the first capacitor C1 may be connected to the fifth node N5. A first end of the second capacitor C2 may be connected to the ground terminal, and a second end of the second capacitor C2 may be connected to the sixth node N6.

The capacity of the second capacitor C2 may be the same as or different from the capacity of the first capacitor C1. For example, the capacity of the second capacitor C2 may be larger than the capacity of the first capacitor C1, and the capacity of the second capacitor C2 may be 1.5 times the capacity of the first capacitor C1. However, the present inventive concept may not be limited thereto.

A first end of the first switch S1 may be connected to the fourth node N4, and a second end of the first switch S1 may be connected to the fifth node N5 and to the second end of the first capacitor C1. A first end of the second switch S2 may be connected to the fifth node N5, and a second end of the second switch S2 may be connected to the sixth node N6. In detail, the first end of the second switch S2 may be connected to the second end of the first capacitor C1, and the second end of the second switch S2 may be connected to the second end of the second capacitor C2.

The on or off-state of the first switch S1 may be controlled by the reference on-time signal ON_TIME_REF, and the on or off-state of the second switch S2 may be controlled by the inverted reference on-time signal ON_TIME_REFB. The reference on-time signal ON_TIME_REF and the inverted reference on-time signal ON_TIME_REFB may be complementary, and detailed embodiments thereof may be similar to those described previously in FIGS. 2 and 3.

FIG. 5 may illustrate the operation of the pulse skip reference voltage generation circuit 700 during the reference on-time. Referring to FIG. 3 together, during the reference on-time, the reference on-time signal ON_TIME_REF may be at a high level, and the inverted reference on-time signal ON_TIME_REFB may be at a low level. Therefore, during the reference on-time, the first switch S1 may be in the on-state and the second switch S2 may be in the off-state.

In some example embodiments, the pulse skip reference voltage generation circuit 700 may sample the sensing voltage VSEN in the first capacitor C1 during the reference on-time. In detail, the sensing voltage VSEN may be charged in the first capacitor C1 during the reference on-time.

FIG. 6 may illustrate the operation of the pulse skip reference voltage generation circuit 700 during the off-time. Referring to FIG. 3 together, during the off-time, the reference on-time signal ON_TIME_REF may be at a low level, and the inverted reference on-time signal ON_TIME_REFB may be at a high level. Therefore, during the off-time, the first switch S1 may be in the off-state and the second switch S2 may be in the on-state.

In some example embodiments, the pulse skip reference voltage generation circuit 700 may hold the sampled sensing voltage VSEN in the first capacitor C1 and the second capacitor C2 during the off-time. In detail, a portion of the sensing voltage VSEN charged in the first capacitor C1 may be transferred to the second capacitor C2 during the off-time. In this case, the voltage of the sixth node N6, which is the voltage between both ends of the second capacitor C2, may correspond to the pulse skip reference voltage VPSK_REF.

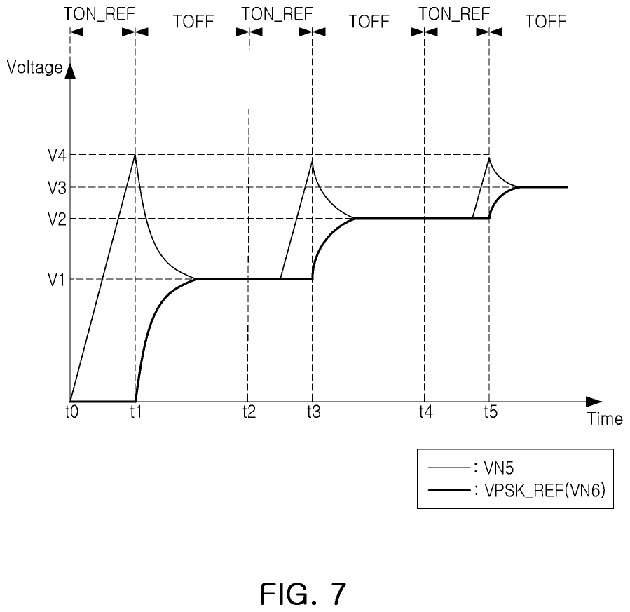

Below, the pulse skip reference voltage VPSK_REF is described in detail with reference to FIG. 7.

FIG. 7 is a graph illustrating the pulse skip reference voltage according to an example embodiment.

Detailed embodiments of the pulse skip reference voltage generation circuit may be similar to those previously described in FIGS. 4 to 6. The voltage between both ends of the first capacitor C1 may correspond to the voltage VN5 of the fifth node N5. The voltage between both ends of the second capacitor C2 may correspond to the voltage VN6 of the sixth node N6.

Referring to FIGS. 4 to 6 together, the pulse skip reference voltage generation circuit of an example embodiment may sample the sensing voltage VSEN in the first capacitor C1 during the reference on-time TON_REF. At this time, the voltage VN5 of the fifth node N5 may be equal to the sensing voltage VSEN during the reference on-time TON_REF. The detailed embodiment of the sensing voltage VSEN may be similar to that described previously in FIG. 3.

Additionally, the pulse skip reference voltage generation circuit of an example embodiment may hold the sampled sensing voltage VSEN in the first capacitor C1 and the second capacitor C2 during the off-time TOFF. Accordingly, at the end of the off-time TOFF, the voltage VN5 of the fifth node N5 may be equal to the voltage VN6 of the sixth node. The voltage VN6 of the sixth node N6 may be the pulse skip reference voltage VPSK_REF.

FIG. 7 illustrates changes over time in the pulse skip reference voltage VPSK_REF and the voltage VN5 of the fifth node N5 according to an example embodiment. In detail, FIG. 7 may illustrate the process of generating the pulse skip reference voltage VPSK_REF. For example, the capacity of the capacitor C1 may be the same as the capacity of the second capacitor C2. The reference on-time TON_REF and off-time TOFF may be kept constant. At a zero time point t0, both the pulse skip reference voltage VPSK_REF and the voltage VN5 of the fifth node N5 may be 0.

The first switch S1 is changed to the on-state at the zero time point to, and the voltage of the first capacitor C1 may be sampled until the first time point t1. The voltage VN5 of the fifth node N5 may rise to the level of the fourth voltage V4 at the first time point t1. For example, the fourth voltage V4 may correspond to the peak value of the sensing voltage. From the zero time point t0 to a first time point t1, the second switch S2 may be maintained in the off-state, and the pulse skip reference voltage VPSK_REF may be maintained at 0.

At the first time point t1, the first switch S1 is changed to the off-state and the second switch S2 is changed to the on-state, and the voltage may be held in the first capacitor C1 and the second capacitor C2 until the second time point t2. The pulse skip reference voltage VPSK_REF and the voltage VN5 of the fifth node N5 may be the first voltage V1 at the second time point t2. For example, the first voltage V1 may correspond to 0.5 times the fourth voltage V4. However, the first voltage V1 is not limited thereto and may change depending on the capacities of the first and second capacitors C1 and C2.

At the second time t2, the first switch S1 is changed to the on-state and the second switch S2 is changed to the off-state, so that the voltage of the first capacitor C1 may be sampled until the third time point t3. The voltage VN5 of the fifth node N5 may rise to the fourth voltage V4 at the third time point t3. From the second time point t2 to the third time point t3, the second switch S2 may be maintained within the off-state, and the pulse skip reference voltage VPSK_REF may be maintained at the first voltage V1.

At the third time point t3, the first switch S1 is changed to the off-state and the second switch S2 is changed to the on-state, and the voltage may be held in the first capacitor C1 and the second capacitor C2 until the fourth time point t4. The voltage VN5 of the fifth node N5 and the pulse skip reference voltage VPSK_REF may be the second voltage V2 at the fourth time point t4. For example, the second voltage V2 may correspond to 0.75 times the fourth voltage V4. However, the second voltage V2 is not limited thereto, and may change depending on the capacities of the first and second capacitors C1 and C2.

By repeatedly performing voltage sampling and holding as described above, a pulse skip reference voltage VPSK_REF with a constant value may be generated. The pulse skip reference voltage VPSK_REF may be close to the fourth voltage V4. In detail, the pulse skip reference voltage VPSK_REF may fall within a predetermined range of the peak value of the sensing voltage at the end of the reference on-time. For example, the predetermined range may be between 90% and 100% of the peak value of the sensing voltage, though it is not limited to this range.

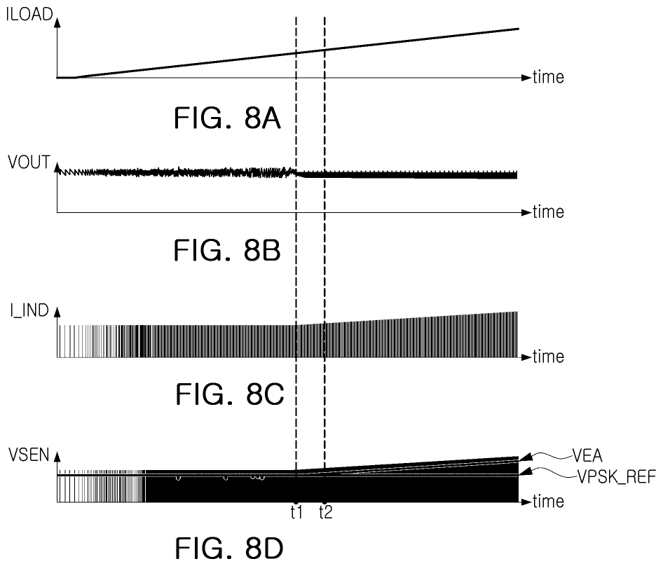

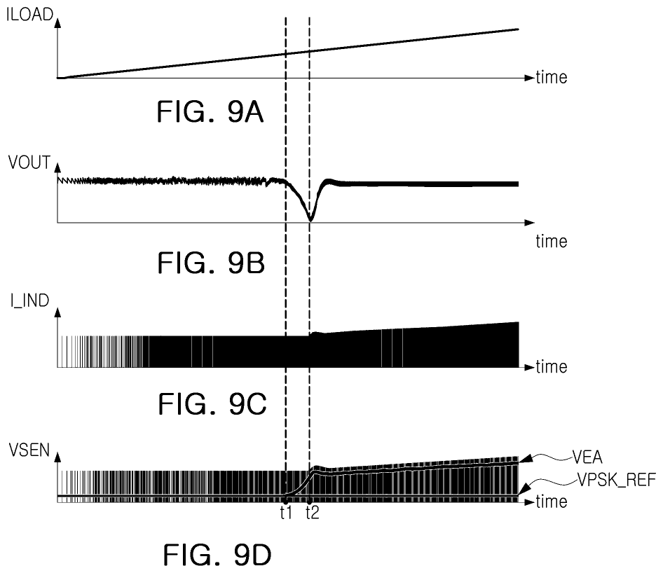

FIGS. 8A, 8B, 8C, 8D, 9A, 9B, 9C, and 9D are diagrams illustrating the operation of a DC-DC converter according to an example embodiment.

FIGS. 8A, 8B, 8C, 8D, 9A, 9B, 9C, and 9D may illustrate operation simulation results of the DC-DC converter of each example embodiment and comparative example. The DC-DC converter, in an example embodiment, may generate a pulse skip reference voltage close to the peak value of the sensing voltage by sampling the sensing voltage during the reference on-time. In contrast, the DC-DC converter in a comparative example, which differs from the example embodiment, samples the sensing voltage during the off-time, resulting in a pulse skip reference voltage close to the low level of the sensing voltage.

FIGS. 8A and 9A may represent the load current ILOAD according to time, the unit of time may be ms (milliseconds) and the unit of load current may be mA (milliamperes). FIGS. 8B and 9B may represent the output voltage VOUT according to time (Time), the unit of time is ms (milliseconds), and the unit of output voltage VOUT is V (volts).

FIGS. 8C and FIG. 9C may represent the inductor current I_IND according to time (Time), the unit of time may be ms (milliseconds), and the unit of inductor current I_IND may be mA (milliamperes). FIGS. 8D and 9D may represent the error amplification voltage VEA, sensing voltage VSEN, and pulse skip reference voltage VPSK_REF according to time (Time). The unit of time may be ms (milliseconds), and the unit of the voltages may be mV (millivolts).

Referring to FIGS. 8A and 9A before the first time point t1, no load or a light load may be applied to the DC-DC converters of the example embodiments and comparative examples. The DC-DC converters of the example embodiments and comparative examples may operate in a pulse skip mode and skip the switching cycle. The smaller the load current ILOAD, the more switching cycles may be skipped.

Referring to FIGS. 8A, 8B, 8C, 8D, 9A, 9B, 9C, and 9D before the mode change time point, the peak value of the inductor current I_IND before the first time point t1 may be maintained within a predetermined range. Accordingly, the output voltage VOUT may also be maintained within a predetermined range, and the peak value of the sensing voltage VSEN may also be maintained within a predetermined range.

Referring to FIGS. 8A and 9A, as the load current ILOAD increases linearly, a heavy load may be applied to the DC-DC converters of example embodiments and comparative examples after the first time point t1.

Referring to the first time point t1 in FIG. 8D, the pulse skip reference voltage VPSK_REF of the example embodiment may be close to the peak value of the sensing voltage VSEN. The error amplification voltage VEA may have a value close to the pulse skip reference voltage VPSK_REF due to the feedback structure of the error amplification circuit. In detail, the error amplification voltage VEA may be close to the peak value of the sensing voltage VSEN.

In the DC-DC converter of the example embodiment, the error amplification voltage VEA is close to the peak value of the sensing voltage VSEN, and may thus be increased to the peak value or more of the sensing voltage VSEN within a short period of time from the first time point t1. Thereafter, the DC-DC converter of the example embodiment may operate in a normal mode, and the on-time may be increased to a minimum on-time or more.

Referring to FIG. 8C, the inductor current I_IND in the example embodiment may be stably increased after the first time point t1. Referring to FIG. 8B, the output voltage VOUT may be maintained within a predetermined range without overshoot or undershoot occurring after the first time point t1.

In contrast, referring to the first time point t1 in FIG. 9D, the pulse skip reference voltage VPSK_REF of the comparative example may be close to the low level of the sensing voltage VSEN. The error amplification voltage VEA may have a value close to the pulse skip reference voltage VPSK_REF due to the feedback structure of the error amplification circuit. In detail, the error amplification voltage VEA may be close to a low level of the sensing voltage VSEN.

In the DC-DC converter of the comparative example, the error amplification voltage VEA may increase from the first time point t1 and may increase to the peak value or more of the sensing voltage VSEN at the second time point t2. The DC-DC converter of the comparative example may be maintained in the pulse skip mode until the second time point t2, and the on-time may be maintained at a minimum on-time.

Referring to FIG. 9C, the peak value of the inductor current I_IND may be maintained within a predetermined range until the second time point t2 and increase after the second time point t2. Referring to FIG. 9B, the power output to the load is insufficient from the first time point t1 to the second time point t2, and thus, an undershoot may occur in the output voltage VOUT. Additionally, referring to FIG. 9C, a ripple may occur in the inductor current I_IND at the second time point t2. In detail, in the DC-DC converter of the comparative example, the peak value of the inductor current does not increase in the mode switching section, and thus, the output of the DC-DC converter may be unstable.

The above differences may arise based on when the sensing voltage is sampled to generate the pulse skip reference voltage. In the DC-DC converter of the comparative example, which differs from the present inventive concept, the sensing voltage is sampled during the off-time, resulting in a pulse skip reference voltage that is close to the low level of the sensing voltage. Therefore, when switching modes of the DC-DC converter, overshoot or undershoot may occur in the output voltage of the DC-DC converter.

In the DC-DC converter of an example embodiment of the present inventive concept, the sensing voltage is sampled during the reference on-time, resulting in a pulse skip reference voltage close to the peak value of the sensing voltage. This approach helps prevent overshoot or undershoot in the output voltage when switching modes of the DC-DC converter, thereby maintain stable output voltage of the DC-DC converter.

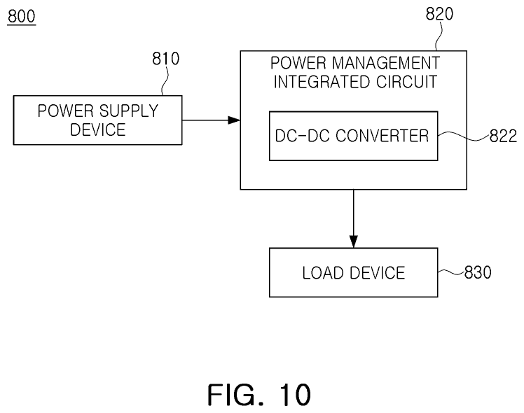

FIG. 10 is a block diagram of an electronic device including a DC-DC converter according to an example embodiment of the present inventive concept.

Referring to FIG. 10, an electronic device 800 may include a power supply device 810, a power management integrated circuit 820 including a DC-DC converter 822, a load device 830, and the like. The electronic device 800 may be, but is not limited to, a mobile device, a personal computer (PC), an In-Vehicle Infotainment (IVI) system, or an In-car entertainment (ICE) system.

The power supply device 810 may correspond to a device that generates direct current voltage. The direct current voltage generated by the power supply device 810 may be used as the input voltage of the DC-DC converter 822. The power supply device 810 may be a battery or a voltage regulator. The battery may include a non-rechargeable primary cell, a rechargeable secondary cell, or a fuel cell. However, the present inventive concept may not be limited thereto.

The power management integrated circuit 820 may supply power to the load device 830 and adjust the level of voltage or current of the power to be supplied to the load device 830. The DC-DC converter 822 may convert the input voltage and output an output voltage to the load device 830. Detailed embodiments of the DC-DC converter 822 may be similar to those previously described in FIGS. 1 to 10.

In some example embodiments, the DC-DC converter 822 may include a voltage conversion circuit, a current detection circuit, a pulse skip reference voltage generation circuit, and a control circuit. The voltage conversion circuit may include an inductor, an output capacitor, a first switching element, and a second switching element. The current detection circuit may generate a sensing current by detecting the inductor current during the on-time.

The pulse skip reference voltage generation circuit may generate a sensing voltage and a pulse skip reference voltage using sensing current. In some example embodiments, the pulse skip reference voltage generation circuit may include a first capacitor and a second capacitor. The pulse skip reference voltage generation circuit may generate a pulse skip reference voltage by sampling the sensing voltage in the first capacitor during the reference on-time and holding the sensing voltage sampled in the first capacitor and the second capacitor during the off-time. In detail, the pulse skip reference voltage generation circuit in some example embodiments may sample the sensing voltage during the reference on-time, and the pulse skip reference voltage may be close to the peak value of the sensing voltage.

The control circuit may include an error amplifier that compares a feedback voltage proportional to the output voltage and a reference voltage and outputs an error amplification voltage based on this comparison. The control circuit may use the pulse skip reference voltage and error amplification voltage to determine whether to skip the pulse of the voltage conversion circuit, and may control the on-time using the sensing voltage and error amplification voltage.

The load device 830 may be an electronic component driven using the output voltage received through the power management integrated circuit 820. The load device 830 may include a processor, a memory, a communication module, a display module, and/or a camera module. However, the present inventive concept may not be limited thereto.

The DC-DC converter 822 of an example embodiment may supply a stable output to the load device 830 by preventing overshoot or undershoot in the mode switching section between the pulse skip mode and normal mode.

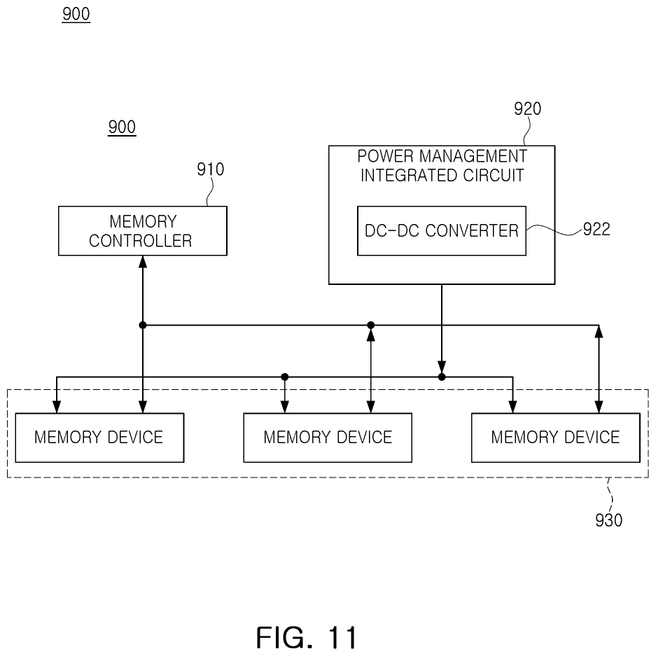

FIG. 11 is a block diagram of an electronic device including a DC-DC converter according to an example embodiment.

Referring to FIG. 11, an electronic device 900 may include a memory controller 910, a power management integrated circuit 920 including a DC-DC converter 922, a plurality of memory devices 930, and the like. The electronic device 900 may be, but is not limited to, a server solid state drive (SSD) or a memory module.

The memory controller 910 may control each of the plurality of memory devices 930. The memory controller 910 may allocate and manage addresses for a plurality of memory devices 930 and manage data transmitted to the plurality of memory devices 930. Additionally, the memory controller 910 may manage caches for the plurality of memory devices 930 and detect errors occurring in the plurality of memory devices 930.

The power management integrated circuit 920 may supply power to each of the plurality of memory devices 930 and adjust the level of voltage or current for power to be supplied to the plurality of memory devices 930. For example, the DC-DC converter 922 may convert an input voltage and output an output voltage to a plurality of memory devices 930. The input voltage may be a direct current voltage generated by a power supply device. Detailed embodiments of the DC-DC converter 922 may be similar to those previously described in FIGS. 1 to 10.

The plurality of memory devices 930 may be volatile memory devices or non-volatile memory devices. The volatile memory device may correspond to a dynamic random access memory (DRAM), and the non-volatile memory device may correspond to a flash memory device. However, the present inventive concept may not be limited thereto.

The DC-DC converter 922 of an example embodiment may prevent overshoot or undershoot in the mode switching section between pulse skip mode and normal mode, and supply a stable output to each of the plurality of memory devices 930.

As set forth above, according to some example embodiments, a DC-DC converter may generate a pulse skip reference voltage that acts as a standard for the pulse skip mode operation. Specifically, the pulse skip reference voltage is generated based on the end point of the minimum on-time section that energizes inductor current flowing through an inductor. Consequently, in the transition between the pulse skip mode and the normal mode, the inductor current can adjust smoothly with changes in load. This prevents overshoot or undershoot in the DC-DC converter's output, ensuring stable output.

While example embodiments have been illustrated and described above, it will be apparent to those skilled in the art that modifications and variations can be made without deviating from the scope of the present inventive concept as set forth by the appended claims.

What is claimed is:

1. A direct current (DC)-DC converter comprising:
a voltage conversion circuit that includes an inductor and an output capacitor, and converts an input voltage and to produce an output voltage;
a current detection circuit that detects an inductor current and generates a sensing current during an on-time, energizing the inductor current flowing through the inductor;
a pulse skip reference voltage generation circuit that generates a sensing voltage and a pulse skip reference voltage using the sensing current; and
a control circuit that determines whether to skip a pulse of the voltage conversion circuit and controls the on-time, using the sensing voltage, the pulse skip reference voltage, and a feedback voltage proportional to the output voltage,
wherein the pulse skip reference voltage generation circuit generates the pulse skip reference voltage by sampling the sensing voltage during a reference on-time.

2. The DC-DC converter of claim 1, wherein the sensing voltage has a peak value at an end of the reference on-time, and
the pulse skip reference voltage is within a predetermined range of the peak value of the sensing voltage.

3. The DC-DC converter of claim 2, wherein the predetermined range is between 90% and 100% of the peak value of the sensing voltage.

4. The DC-DC converter of claim 1, wherein the control circuit includes an error amplifier that compares the feedback voltage with a reference voltage and outputs an error amplification voltage, and determines whether to skip the pulse of the voltage conversion circuit using the pulse skip reference voltage and the error amplification voltage.

5. The DC-DC converter of claim 4, wherein the voltage conversion circuit skips pulses for a time when a level of the pulse skip reference voltage is equal to or higher than a level of the error amplification voltage.

6. The DC-DC converter of claim 5, wherein the pulse skip involves skipping at least one on-time by the voltage conversion circuit.

7. The DC-DC converter of claim 1, wherein the control circuit includes an error amplifier that compares the feedback voltage with a reference voltage and outputs an error amplification voltage, and
the control circuit controls the on-time using the sensing voltage and the error amplification voltage.

8. The DC-DC converter of claim 7, wherein when a point at which a level of the sensing voltage exceeds a level of the error amplification voltage occurs within the reference on-time, the on-time is equal to the reference on-time.

9. A direct current (DC)-DC converter comprising:
a voltage conversion circuit that includes an inductor, an output capacitor, a first switching element, and a second switching element, and converts an input voltage to produce an output voltage;
a current detection circuit that generates a sensing current by detecting an inductor current during an on-time, energizing the inductor current flowing through the inductor;
a pulse skip reference voltage generation circuit that generates a sensing voltage and a pulse skip reference voltage using the sensing current; and
a control circuit including an error amplifier that outputs an error amplification voltage by comparing a feedback voltage proportional to the output voltage with a reference voltage, determines whether to skip a pulse of the voltage conversion circuit using the pulse skip reference voltage and the error amplification voltage, and controls the on-time using the sensing voltage and the error amplification voltage,
wherein the pulse skip reference voltage generation circuit includes a first capacitor, a second capacitor, a first switch and a second switch, samples the sensing voltage in the first capacitor during a reference on-time, and generates the pulse skip reference voltage by holding the sampled voltage in the first capacitor and the second capacitor during an off-time when the inductor current flowing in the inductor is de-energized.

10. The DC-DC converter of claim 9, wherein the first capacitor and the second capacitor are connected in parallel, and a first end of the first capacitor and a first end of the second capacitor are connected to a ground.

11. The DC-DC converter of claim 10, wherein the first switch and the second switch are connected in series, and
a first end of the second switch is connected to a second end of the first capacitor, and a second end of the second switch is connected to a second end of the second capacitor.

12. The DC-DC converter of claim 11, wherein the pulse skip reference voltage is a voltage between the first and second ends of the second capacitor.

13. The DC-DC converter of claim 11, wherein one of the first switch and the second switch is on.

14. The DC-DC converter of claim 13, wherein during the reference on-time, the first switch is on and the sensing voltage is sampled in the first capacitor.

15. The DC-DC converter of claim 13, wherein during the off-time, the second switch is on and the sampled voltage is held in the first capacitor and the second capacitor.

16. The DC-DC converter of claim 9, wherein a capacity of the second capacitor is equal to a capacity of the first capacitor.

17. The DC-DC converter of claim 9, wherein a capacity of the second capacitor is greater than a capacity of the first capacitor.

18. The DC-DC converter of claim 17, wherein the capacity of the second capacitor is 1.5 times the capacity of the first capacitor.

19. A direct current (DC)-DC converter comprising:
a voltage conversion circuit that includes an inductor, an output capacitor, a first switching element and a second switching element, and converts an input voltage to produce an output voltage;
a current detection circuit that generates a sensing current by detecting an inductor current during an on-time, energizing the inductor current flowing through the inductor;
a pulse skip reference voltage generation circuit that includes a first capacitor and a second capacitor connected in parallel, and a first switch and a second switch connected in series, and generates a sensing voltage and a pulse skip reference voltage using the sensing current; and
a control circuit including an error amplifier that outputs an error amplification voltage by comparing a feedback voltage proportional to the output voltage with a reference voltage, determines whether to skip a pulse of the voltage conversion circuit using the pulse skip reference voltage and the error amplification voltage, and controls the on-time using the sensing voltage and the error amplification voltage,
wherein in the pulse skip reference voltage generation circuit,
a first end of the first capacitor and a first end of the second capacitor are connected to ground, a second end of the first capacitor is connected to a node between the first switch and the second switch, and a second end of the second capacitor is connected to the second switch, and
the sensing voltage is sampled in the first capacitor by maintaining the first switch in an on-state during a reference on-time, the sampled voltage is held in the first capacitor and the second capacitor by maintaining the second switch in an on-state during an off-time when the inductor current is de-energized, and the pulse skip reference voltage is generated, and
the voltage conversion circuit skips pulses when the pulse skip reference voltage is greater than the error amplification voltage.

20. The DC-DC converter of claim 19, wherein the sensing voltage has a peak value at an end of the reference on-time, and
the pulse skip reference voltage is within 90% to 100% of a peak value of the sensing voltage.
